(19) United States
(12) Patent Application Publication
(10) Pub. No.: US 2008/0189481 A1
(43) Pub. Date: Aug. 7, 2008

(54) METHODS AND SYSTEMS FOR STORING DATA BASED ON A RELIABILITY REQUIREMENT

(76) Inventors: Peter Mayer, Neubiberg (DE); Wolfgang Spirkl, Germering (DE); Markus Balb, Munich (DE); Christoph Bilger, Munich (DE); Martin Brox, Munich (DE); Thomas Hein, Munich (DE); Michael Richter, Ottobrunn (DE)

Correspondence Address: PATTERSON & SHERIDAN, LLP;Gero McClellan / Qimonda, 3040 POST OAK BLVD.,, SUITE 1500, HOUSTON, TX, 77056, US

(21) Appl. No.: 11/672,427

(22) Filed: Feb. 7, 2007

(51) Int. Cl. G06F 12/00

(52) U.S. Cl. 711/111; 711/E12.001

(57) ABSTRACT

Methods and apparatus for storing data in different regions of the memory device based on, for example, a reliability requirement of the data. A memory controller may determine a category for data, for example, high reliability data and low reliability data, prior to storing the data in memory. The data may be stored in a region of memory associated with the category of data according to a method associated with the category of data. For example, high reliability data may be stored in a particular region of memory using lower clock frequencies, with additional error correction bits, and/or at multiple redundant locations. In contrast, low reliability data may be stored other regions of the memory using higher clock frequencies, without additional error correction bits and/or at singular locations (i.e., without redundant locations.

### BACKGROUND OF THE INVENTION

1. Field of the Invention

The present invention generally relates to storing data in a memory device, and more specifically to storing data in different regions of the memory device based on a reliability requirement of the data.

2. Description of the Related Art

Memories play a significant role in devices such as computers, servers, routers, workstations, cell-phones, Personal Digital Assistants (PDAs), and a myriad of other electronics devices. The memory in such devices may be used to store data and programming necessary to operate the device. For example, a processor, or memory controller may be configured to access data or a program contained in the memory to operate the device.

In recent years, in response to the demand for devices with greater performance, the processing power of electronic devices has greatly increased. However, the increase in processing power of devices has been achieved in the absence of a commensurate increase in memory speed. Therefore, accessing memory continues to be a performance bottleneck.

Several efforts have been made to improve memory speed. Improving memory speed has typically involved increasing memory bandwidth. Memory bandwidth may be defined as the number of bits of data transferred to or from memory per second. Memory bandwidth may be increased by speeding up the memory clock, increasing the width of the memory bus, or both. However, in conventional memory devices, such approaches are reaching their practical limits.

One problem with increasing memory bandwidth is that with increasing frequencies of memory clocks, the reliability of data transmitted to and from memory has decreased. For example, modern devices are frequently plagued with errors such as Single-Bit Fails (SBFs) and Multi-Bit Fails (MBFs). A single bit fail may occur when an error occurs in the transfer of a single bit out of a plurality of bits of transmitted data. A multi bit error may occur when an error occurs in the transfer of multiple bits of data. Studies show that a large majority of transmission errors are single bit failures.

In addition to high clock frequencies, single and multiple bit failures can be caused by a wide variety of reasons, for example, transient faults caused by fluctuations in environmental conditions such as temperature, voltage, humidity, pressure, vibrations, power supply fluctuations, electromagnetic interference, or non environmental conditions such as loose connections, aging device components, system noise, and the like.

To avoid problems caused by single and multiple bit failures, designers typically incorporate various forms of data protection, for example, parity bits, Error Correction Code (ECC), chipkill, and the like. However, while such data protection schemes provide greater reliability, they come at an increased cost to the system. For example, the use of data protection schemes reduces memory bandwidth due to the incorporation of data protection bits along with data during memory transfers, thereby negatively affecting performance.

Therefore, what is needed are improved methods and systems for achieving greater memory performance while maintaining reliability of data transmission.

### SUMMARY OF THE INVENTION

The present invention generally relates to storing data in a memory device, and more specifically to storing data in different regions of the memory device based on a reliability requirement of the data.

Embodiments of the invention provide methods, systems, and articles of manufacture for storing data in a memory device. A memory device may include a plurality of storage regions, wherein each of the plurality of storage regions is associated with one of at least two different categories of data. When data is received for storage in the memory device, a category of the received data may be determined from the at least two different categories. Each category may have a respective access method for storing data to the memory device. Data may be stored in one of the storage regions associated with the determined category of the received data, wherein the storing is done according to the respective access method associated with the determined category.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 illustrates an exemplary system according to an embodiment of the invention.

FIG. 2 illustrates a mode register according to an embodiment of the invention.

FIG. 3 is a flow diagram of exemplary operation performed to store data in a memory device, according to an embodiment of the invention.

### DETAILED DESCRIPTION OF THE PREFERRED EMBODIMENT

Embodiments of the invention generally relate to storing data in a memory device, and more specifically to storing data in different regions of the memory device based on a reliability requirement of the data. A memory controller may determine a category for data, for example, high reliability data and low reliability data, prior to storing the data in memory. The data may be stored in a region of memory associated with the category of data according to a method associated with the category of data. For example, high reliability data may be stored in a particular region of memory using lower clock frequencies, lower data rates, with additional error correction bits, and/or at multiple redundant locations. In contrast, low reliability data may be stored other regions of the memory using higher clock frequencies, without additional error correction bits and/or at singular locations (i.e., without redundant locations.

In the following, reference is made to embodiments of the invention. However, it should be understood that the invention is not limited to specific described embodiments. Instead, any combination of the following features and elements, whether related to different embodiments or not, is contemplated to implement and practice the invention. Furthermore, in various embodiments the invention provides numerous advantages over the prior art. However, although embodiments of the invention may achieve advantages over other possible solutions and/or over the prior art, whether or not a particular advantage is achieved by a given embodiment is not limiting of the invention. Thus, the following aspects, features, embodiments and advantages are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

### Exemplary System

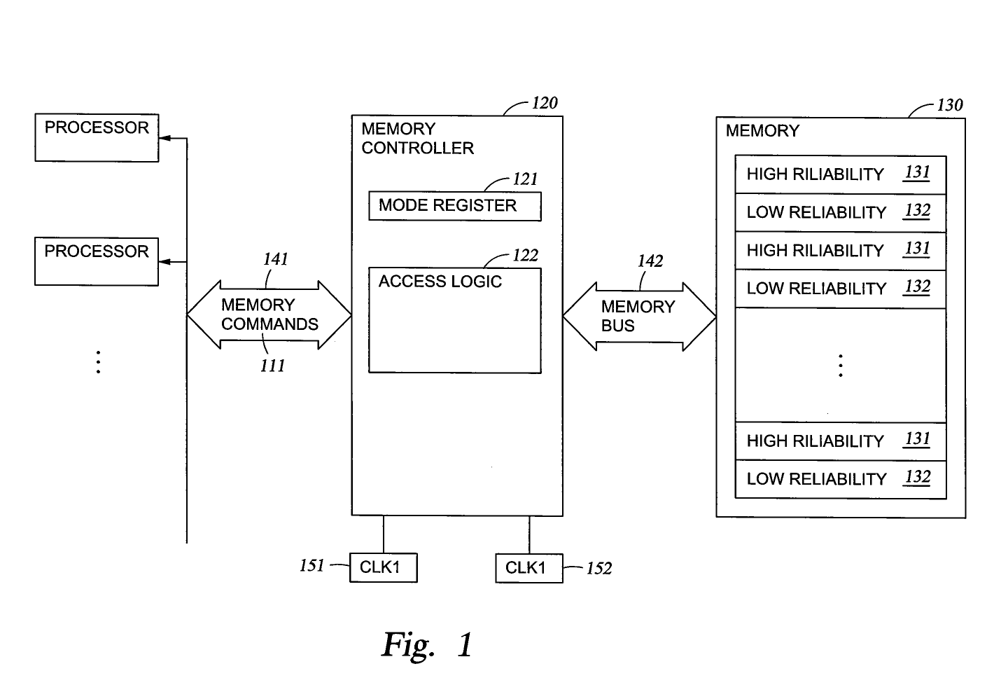

FIG. 1 illustrates an exemplary system 100 in which embodiments of the invention may be implemented. As illustrated in FIG. 1, system 100 may include one or more processors 110 (two such processors 110 are shown in FIG. 1), a memory controller 120 and memory 130. In one embodiment, memory 130 is preferably a random access memory, for example, a dynamic random access memory (DRAM); however, more generally, memory 130 may be any type of memory, including flash memory. While the memory 130 is shown as a single entity, it should be understood that the memory 130 may in fact comprise a plurality of modules, and that the memory 130 may exist at multiple levels, from high speed registers and caches to lower speed but larger DRAM chips.

Processors 110 may be communicably coupled to memory controller 120 via a bus 141. Processors 110 may be configured to issue one or more memory commands 111 to memory controller 120. For example, the processors 110 may be configured to issue read and write commands to transfer data to, and retrieve data from, memory 130 via memory controller 120.

Memory controller 120 may be configured to perform a plurality of operations on memory 130. For example, in response to receiving commands 111, memory controller 110 may be configured to access memory 130. For example, if a read command is received, memory controller 120 may be configured to retrieve data from memory 130. Alternatively, if a write operation is received, memory controller 120 may be configured to store data in memory 130.

Memory controller 120 may also be configured to perform refresh operations at regular intervals on memory 130. For example, memory 130 may be dynamic random access memory requiring periodic refresh cycles. During the refresh cycle, data may be read from and written back to each memory location to avoid loss of data due to discharging capacitors in DRAM memory cells.

Memory controller 120 may be communicably coupled with memory 130, for example, via a memory bus 142. Memory bus 142 may be configured to transfer control signals, for example, write enable, chip select, data available, and the like. Memory bus 142 may also comprise a plurality of data and address lines. The address lines may be configured to transfer an address representing a memory location for storing or retrieving data. The data lines may be configured to transfer data to and from identified memory locations. In one embodiment of the invention, one or more lines of memory bus 142 may be configured to transfer both address bits and data bits.

In some embodiments of the invention, data transferred to memory 130 may be classified into one or more categories. For example, in one embodiment, data may be classified as high reliability data and low reliability data. High reliability data may be data that is critical for system performance. For example, high reliability data may include system code and data. Because such system code and data (hereinafter referred to collectively as system data) may be crucial to the operation of the system, the integrity of the system data must be maintained during exchange of the data with memory 130.

As discussed previously, the transmission of data across memory bus 142 may cause single bit errors or multi bit errors because of the relatively high clock speeds employed while exchanging data with memory. Such single and multi bit errors may have a catastrophic affect on the system. For example, a processor 110 may include a register for storing system data, for example, an address associated with system code. The system data may be transferred from the register to memory 130 to make the register available for other purposes. One or more bits of the system data may be altered during transfer of the system data to memory 130. Therefore, when the system data is transferred back into the register, the data may be erroneous, thereby preventing the processor from accessing system code and causing a hang-up of the system.

In contrast, the effect of single bit and multi bit errors on low reliability data may not be as catastrophic. Low reliability data may include, for example, pixel data that determines the contents of a display associated with the system. For example, pixel data may determine the color of a pixel on a display screen. Because each pixel forms a relatively small portion of the screen defects in the pixel data caused by single and multi bit errors may not be noticeable. Furthermore, pixel data may be updated at relatively high frequencies, for example, once every microsecond. Therefore, the defects caused by single and multi bit errors may be updated without any catastrophic affect on the system.

In one embodiment of the invention, memory 130 may be divided into a plurality of regions, wherein each region stores a particular category of data. For example, referring to FIG. 1, memory 130 may include one or more high reliability regions 131 and one or more low reliability regions 132 (three high reliability regions and three low reliability regions are shown). High reliability data may be stored in a high reliability region 131, and low reliability data may be stored in a low reliability region 132.

One skilled in the art will recognize that embodiments of the invention are not limited to categorization of memory regions into high reliability and low reliability regions. More generally, data may be classified into any number of categories, for example, high reliability, low reliability, and one or more medium reliability categories, with associated regions in memory 130.

### Identification of Data Type

In some embodiments of the invention, the method of storing data to memory may depend on the particular category of the data. For example, if high reliability data is received by the memory controller, the data may be stored, for example, using a slower clock frequency and/or using additional error correction bits. The particular methods for storing data are discussed in greater detail below. However, prior to storing data in memory device 130, memory controller 120 may first identify a category of the data to determine the method for storing the data.

In one embodiment of the invention, memory controller 120 may include a mode register 121 to identify one or more address ranges in memory 130. Each address range may define a memory region and may be associated with a particular category of data, for example, high reliability data and low reliability data.

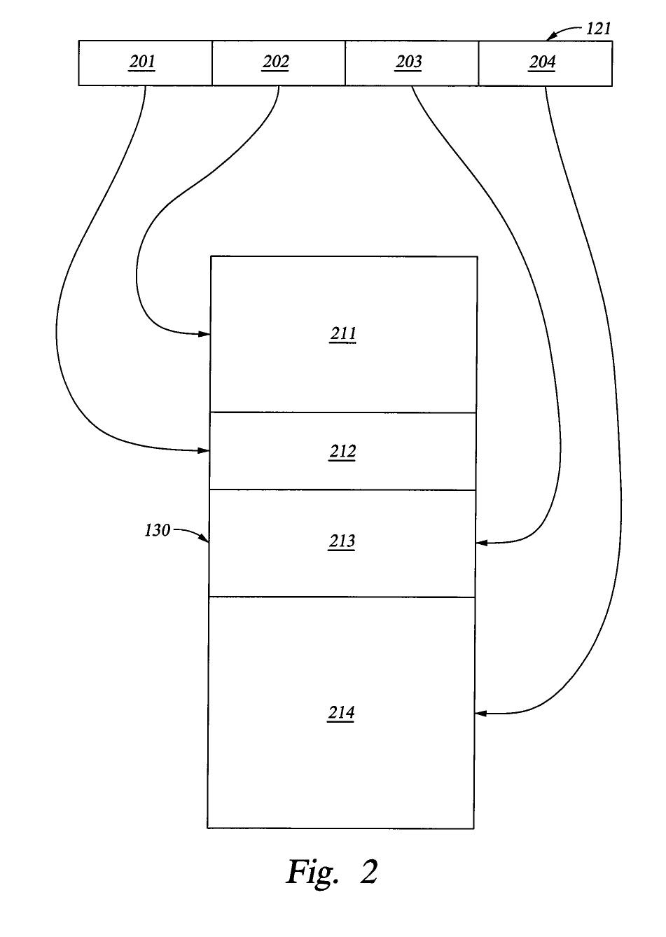

FIG. 2 illustrates an exemplary register 121 according to an embodiment of the invention. As illustrated, register 121 may be divided into a plurality of sections, each section corresponding to a particular category. For example, register 121 is divided into four sections 201, 202, 203, and 204. Each section may identify an address range for data belonging to a particular category. For example, in FIG. 2, register section 201 defines an address range for region 211 of memory 130. Similarly, register section 202 may define an address range for region 212, register section 203 may define an address range for region 213, and register section 204 may define an address range for region 214 of memory 130.

Referring back to FIG. 1, memory controller 120 may include memory access logic 122 for identifying the category of the data and determining the method for storing data in memory 130. For example, memory controller 120 may receive a write command from a processor 110. The write command may include the data to be written to memory 130 and the address of a location in memory 130 to which the data is to be written. Memory access logic 122 may compare the address received with the write command to the address ranges included in register 121 to determine the category of the data.

For example, memory controller 120 may receive an address that falls within the range specified in section 201 of register 121 (see FIG. 2). In one embodiment, section 201 may define a range for high reliability data. In response to determining that the address received with the write command falls within an address range for high reliability data, memory access logic may determine that the data is high reliability data. Therefore, memory controller 120 may store the data associated with the write command according to a method for storing high reliability data.

In one embodiment of the invention, the address ranges specified in sections 201-204 of register 121 may be adjusted dynamically. The dynamic adjustment of the address ranges may be performed, for example, on the basis of need. For example, in one embodiment, memory controller 120 may determine that sufficient memory is not available for storing high reliability data. In response to determining that sufficient memory is not available for storing high reliability data, memory controller 120 may adjust the address ranges in one or more of sections 201-204 to allocate a greater memory range for storing high reliability data. For example, the adjusted memory ranges may allocate a portion of one or more of the address ranges defined in sections 202-204 to section 201 to increase memory available for high reliability data.

In some embodiments of the invention, commands 111 may determine the category of data. In one embodiment, system 100 of FIG. 1 may be configured to execute a write-high-reliability command, wherein the write-high-reliability command is configured to store data in memory 130 using a method for storing high reliability data. For example, memory controller 120 may receive a write-high-reliability command from a processor 110. The write high reliability command may be an example of commands 111 in FIG. 1. In response to receiving the write-high-reliability command, memory access logic 122 may select a method for writing high reliability data to store data associated with the write-high-reliability command to a high reliability region in memory 130.

System 100 may also be configured to execute a write-low-reliability command, wherein the write-low-reliability command is configured to store data in memory 130 using a method for storing low reliability data. For example, memory controller 120 may receive a write-low-reliability command from a processor 110. In response to receiving the write-low-reliability command, memory access logic 122 may select a method for writing low reliability data to store data associated with the write-low-reliability command to a low reliability region in memory 130.

In one embodiment of the invention, memory 130 may be divided into a plurality of memory banks. Each memory bank may be associated with a particular category of data. For example, a first memory bank may be configured to store high reliability data, a second memory bank may be configured to store low reliability data, and so on. Memory access logic 122 may determine the category associated with data received from a processor, for example, based on a command received from the processor, and select a bank associated with the determined category of data. Memory controller 120 may then select a method for storing the received data and store the data to the selected bank.

### Storing Data to Memory

As previously discussed, increasing the speed of memory clocks results in an increased risk of losing data transferred to and from memory. The data loss may occur, for example, due to single bit and multi-bit errors that may occur during transfer of data to memory. Because catastrophic effects to the system result typically from errors high reliability data, embodiments of the invention provide for different methods for storing data to memory based on a determined category of the data.

For example, in one embodiment of the invention, high reliability data may be stored to memory using a lower memory clock frequency. The lower memory clock frequency may relax timing requirements for storing data, thereby reducing the probability of occurrence of single and multi bit errors.

In one embodiment of the invention, the memory controller may be coupled with one or more memory clocks. For example, referring back to FIG. 1, memory controller 120 is shown coupled with two memory clocks 151 and 152. Each memory clock may provide a clock signal of different frequency to memory controller 120. For example, in one embodiment, clock 151 may provide a clock signal that has a lower frequency than the clock signal provided by clock 152.

Upon determining the category of data, memory access logic 122 of memory controller 120 may select an appropriate clock frequency for storing data to memory. For example, memory access logic 122 may determine that data received from a processor 110 is high reliability data. In response to determining that received data is high reliability data, memory access logic 122 may select a clock signal providing a relatively lower clock frequency, for example, clock 151, for storing the high reliability data in a high reliability region of memory 130.

On the other hand, if it is determined that received data is low reliability data, memory access logic 122 may select a clock signal providing a relatively higher clock frequency, for example, clock 152, for storing the low reliability data in a low reliability region in memory 130. Therefore, embodiments of the invention may select a lower clock frequency while writing high reliability data to memory, thereby reducing the occurrence of single and multi bit errors. In contrast, low reliability data may be stored to memory at higher clock frequencies. Accordingly, catastrophic effects to the system as a result of single and multi bit errors can be reduced without adversely affecting performance.

In one embodiment of the invention, a single clock signal may be used to generate a plurality of clock signals with relatively different clock frequencies. For example, in one embodiment, memory controller 120 may be configured to receive a clock signal that has a frequency of, for example, 800 MHz. By altering the clock signal, for example, by using a phase locked loop, to produce a clock edge at the end of every two clock cycles, memory controller 120 may reduce the clock frequency to 400 MHz. Therefore, memory controller 120 may have two clock frequencies available for writing data to memory 130, wherein a first clock frequency is twice the value of a second clock frequency.

One skilled in the art will recognize that embodiments of the invention are not limited to generating only two clock signals from a single clock signal. Rather, any number of clock signals may be generated based on a base clock signal by producing a clock edge after a predefined number of clock cycles of the base clock signal.

The selection between multiple clocks and a single adjustable clock may depend on the particular system architecture. One skilled in the art will recognize that adjusting a single clock to generate multiple clock signals may require a clock stabilization period while adjusting clock frequencies. Therefore, in systems where frequent adjustment of the clock signal is necessary, it may be more advantageous to implement multiple clocks to avoid the clock stabilization period. On the other hand, because multiple clock signals require multiple clock signal lines, in some systems, it may be more advantageous to implement a single clock that may be adjustable to produce multiple clock signals. In some embodiments, multiple clocks may be provided, wherein each clock is adjustable to produce a plurality of clock signals of different frequency.

In one embodiment of the invention data may be written to memory at different data rates based on the category of data. For example, in one embodiment, memory may function at different data rates, for example, single data rate (SDR), double data rate (DDR), quadruple data rate (4DR), and the like. In other words, the number of bits transferred per clock cycle may be adjusted based on the category of data. If the data rate is DDR, for example, two bits may be transferred per clock cycle.

By selecting a smaller data rate for writing high reliability data, the data may be written with relaxed interface timings and higher reliability. For example, high reliability data may be written at SDR and low reliability data may be written at 4DR. In one embodiment of the invention, special read and write commands may determine the selection of the data rate for transferring data to and from memory

In one embodiment of the invention, high reliability data may be stored with additional error correction bits. The error correction bits may include codes for identifying and repairing single and/or multi bit errors. Examples of error correction schemes include parity bits, cyclic redundancy check (CRC), hamming code, and the like. Accordingly memory access logic may be configured to determine a category of the data and generate error correction bits for the data based on the category of the data. For example, a more secure error identification/correction scheme may be selected if the data is high reliability data.

In some embodiments, memory access logic 122 may store low reliability data with fewer or no error correction bits. Because error correction bits need not be sent across, for example, over memory bus 142, more data lines may be available for transferring low reliability data to memory 130, thereby improving memory bandwidth.

Therefore, by allowing high reliability bits to be stored with greater error detection and correction code, embodiments of the invention provide better data security from single and multiple bit errors. Moreover, because low reliability bits are stored with fewer error correction bits, greater memory bandwidth may be achieved while transferring low reliability data. Therefore, overall memory performance is not adversely affected.

In one embodiment of the invention, memory access logic 122 may store high reliability data at two or more locations to identify single bit errors. For example, in one embodiment, memory access logic 122 may store high reliability data received from a processor 110 at a first location in a high reliability region of memory 130. Memory access logic 122 may store the same data at an additional one or more locations of the high reliability region in memory 130. For example, memory access logic 122 may store the high reliability data in one or more consecutive memory locations in memory 130.

When the data is read back from memory 130, the data may be read back from each of the one or more locations containing the data. The data read from each location may be compared by the memory controller to identify and correct errors in the data and/or to select the location where data was stored without errors.

In contrast, low reliability data may be stored at fewer redundant locations. For example, in one embodiment, low reliability data may be stored at a single location because error detection and correction may not be necessary. For example, pixel data, which changes relatively frequently, and has negligible effect on the system, may be stored at fewer or a single redundant location.

While several different methods for storing high reliability data are disclosed herein, one skilled in the art will recognize that embodiments of the invention are not limited to the specifically described methods for storing different categories of data. More generally, any reasonable method for storing data in memory comprising categorizing the data into one or more categories based on a reliability requirement for the data, and storing the data using a method associated with the category of the data in regions of memory associated with the category of data fall within the scope of the invention.

Furthermore, any combination of one or more methods described herein may be used while storing data. For example, high reliability data may be stored at a lower frequency, with additional error correction bits, at multiple redundant locations in a high reliability region of memory 130. Conversely, low reliability data may be stored at higher frequencies, with fewer error correction bits, and at fewer redundant locations.

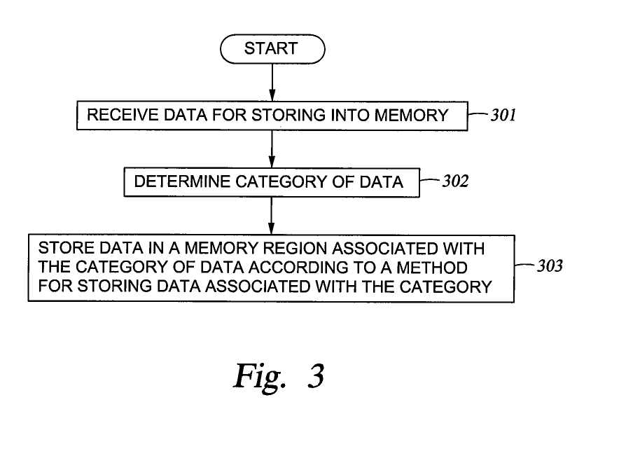

FIG. 3 illustrates a flow diagram of exemplary operations performed by the memory access logic 122 to store data in memory 130. The operations may begin in step 301 by receiving data for storing into a memory device. For example, referring to FIG. 1, memory controller 120 may receive a write command comprising data for storage into memory 130.

In step 302, memory access logic 122 may determine a category of the data. Determining the category of data may involve, for example, comparing an address associated with the write command to one or more address ranges in a mode register. For example, memory access logic 122 may compare an address associated with the write command to the address ranges 201-204 of mode register 200 in FIG. 2. Alternatively, determining a category may involve determining a type of the write command. For example, processors 110 may be configured to issue a write-high-reliability command. Therefore, memory access logic 122 may determine the category of the data based on the type of command received.

In step 303, the data may be stored to memory 130 based on a method for storing data associated with the determined category of the data. For example, in one embodiment, memory access logic may determine that the data received from the processors 110 is high reliability data. Therefore, memory access logic 122 may store the data in a high reliability region of memory 122 according to a method for storing high reliability data. The methods for storing high reliability data may include, for example, storing the data at a lower clock frequency, storing the data with additional error correction bits, storing the data at multiple redundant locations, and the like (including combinations of any of the foregoing methods).

In one embodiment of the invention, memory controller may be configured to perform refresh operations in each of the memory regions at different refresh rates. For example, in one embodiment, memory controller 120 may perform refresh operations in high reliability data regions more frequently relative to the low reliability regions. It is contemplated that the refresh circuitry of memory 130 itself may be configured to perform refresh operations in high reliability regions more frequently relative to the low reliability regions.

By performing refresh operations more frequently in high reliability regions, the reliability of the high reliability data may be maintained. On the other hand by performing refresh operations less frequently in the low reliability regions, unnecessary time consuming refresh operations may be avoided, thereby making that refresh time available for transferring data and improving performance.

### CONCLUSION

By allowing high reliability data to be stored in a region of memory designated for storing high reliability data, and by storing the high reliability data using methods that reduce the occurrence of, or enhance the ability to identify and correct, single and multi bit errors, embodiments of the invention mitigate the catastrophic effects of single and multi bit errors. Low reliability data may be stored using methods that maintain or improve memory bandwidth, thereby avoiding an adverse affects on system performance.

While the foregoing is directed to embodiments of the present invention, other and further embodiments of the invention may be devised without departing from the basic scope thereof, and the scope thereof is determined by the claims that follow.

What is claimed is:

1. A method for storing data in a memory device, comprising:
receiving data for storing into the memory device, wherein the memory device includes a plurality of storage regions, wherein each of the plurality of storage regions is associated with one of at least two different categories of data;
determining a category of the received data from the at least two different categories, wherein each category has a respective access method for storing data to the memory device; and
storing the data in one of the storage regions associated with the determined category of the received data, wherein the storing is done according to the respective access method associated with the determined category.

2. The method of claim 1, wherein determining the category of the received data comprises determining an address range in a mode register comprising a plurality of address ranges, the address range comprising an address of the storage region in which the received data is to be stored, wherein the address range defines the category of the received data.

3. The method of claim 2, wherein the plurality of address ranges in the mode register are dynamically adjustable.

4. The method of claim 1, wherein determining the category of the received data comprises identifying a memory access command issued for storing the received data, wherein the memory access command defines the category of the received data.

5. The method of claim 1, wherein storing the data in the memory device comprises storing the data in one of a plurality of memory banks, wherein the memory bank is associated with the determined category of data.

6. The method of claim 1, wherein the plurality of storage regions comprise at least one high reliability region to store high reliability data and at least one low reliability region to store low reliability data.

7. The method of claim 6, wherein if the category of the received data is determined to be high reliability data, the access method comprises storing the received data at a first clock frequency, and if the category of the received data is determined to be low reliability data, the access method comprises storing the received data at a second clock frequency, wherein the first clock frequency is lower than the second clock frequency.

8. The method of claim 6, wherein if the category of the received data is determined to be high reliability data, the access method storing the received data with a first number of error correction bits, and if the category of the received data is determined to be low reliability data, the access method comprises storing the received data with a second number of error correction bits, wherein the first number of error correction bits is greater than the second number of error correction bits.

9. The method of claim 6, wherein if the category of the received data is determined to be high reliability data, the access method comprises storing the received data at a first number of locations in the memory device, and if the category of the received data is determined to be low reliability data, the access method comprises storing the received data at a second number of locations in the memory device, wherein the first number of locations is greater than the second number of locations.

10. A memory controller configured to:
receive, from at least one processor, data for storing into a memory device;
determine a category of the received data from at least two different categories, wherein each category has a respective access method for storing data to the memory device; and
store the data in the memory device according to the respective access method associated with the determined category of the received data.

11. The memory controller of claim 10, wherein the categories of data comprise high reliability data and low reliability data.

12. The memory controller of claim 11, wherein if the category of the received data is determined to be high reliability data, the memory controller is configured to store the received data at a first clock frequency, and if the category of the received data is determined to be low reliability data, the memory controller is configured to store the received data at a second clock frequency, wherein the first clock frequency is lower than the second clock frequency.

13. The memory controller of claim 11, wherein if the category of the received data is determined to be high reliability data, the memory controller is configured to store the received data with a first number of error correction bits, and if the category of the received data is determined to be low reliability data, the memory controller is configured to store the received data with a second number of error correction bits, wherein the first number of error correction bits is greater than the second number of error correction bits.

14. The memory controller of claim 11, wherein if the category of the received data is determined to be high reliability data, the memory controller is configured to store the received data at a first number of locations in the memory device, and if the category of the received data is determined to be low reliability data, the memory controller is configured to store the received data at a second number of locations in the memory device, wherein the first number of locations is greater than the second number of locations.

15. The memory controller of claim 11, wherein the memory controller is configured to store high reliability data in first region of the memory device and store low reliability data in a second region of the memory device.

16. The memory controller of claim 15, wherein the memory controller is configured to perform refresh operations more often in the first region relative to the second region.

17. A system, comprising:
at least one processor;
a memory device comprising a plurality of storage regions, wherein each of the plurality of storage regions is associated with one of at least two different categories of data; and
a memory controller communicably coupled with the at least one processor and the memory device, wherein the memory controller is configured to:
receive, from the at least one processor, data for storing into the memory device;
determine a category of the received data from the at least two different categories, wherein each category has a respective access method for storing data to the memory device; and
store the data in one of the storage regions associated with the determined category of the received data, wherein storing is done according to the respective access method for associated with the determined category of the received data.

18. The system of claim 17, further comprising a mode register comprising a plurality of address ranges, wherein the memory controller is configured to access the mode register to determine the category of the received data by determining an address range in the mode register, the address range comprising an address of the region in which the received data is to be stored.

19. The system of claim 18, wherein the plurality of address ranges in the mode register are dynamically adjustable.

20. The system of claim 17, wherein the memory controller is configured to determine the category of the received data by identifying a memory access command issued for storing the received data, wherein the memory access command defines the category of the received data.

21. The system of claim 17, wherein the memory device comprises a plurality of memory banks, and the memory controller is configured to store the data in one of the plurality of memory banks, wherein the memory bank is associated with the determined category of data.

22. The system of claim 17, wherein the plurality of storage regions comprise at least one high reliability region to store high reliability data and at least one low reliability region to store low reliability data.

23. The system of claim 22, wherein if the category of the received data is determined to be high reliability data, the memory controller is configured to store the received data at a first clock frequency, and if the category of the received data is determined to be low reliability data, the memory controller is configured to store the received data at a second clock frequency, wherein the first clock frequency is lower than the second clock frequency.

24. The system of claim 23, further comprising a first clock communicably coupled with the memory controller to provide a first clock signal at the first clock frequency, and a second clock communicably coupled with the memory controller to provide a second clock signal at the second clock frequency.

25. The system of claim 23, further comprising an adjustable clock communicably coupled with the memory controller to provide an adjustable clock signal, wherein the memory controller is configured to generate a first clock signal at the first clock frequency and a second clock signal at the second clock frequency from the adjustable clock signal.

26. The system of claim 22, wherein if the category of the received data is determined to be high reliability data, the memory controller is configured to store the received data with a first number of error correction bits, and if the category of the received data is determined to be low reliability data, the memory controller is configured to store the received data with a second number of error correction bits, wherein the first number of error correction bits is greater than the second number of error correction bits.

27. The system of claim 22, wherein if the category of the received data is determined to be high reliability data, the memory controller is configured to store the received data at a first number of locations in the memory device, and if the category of the received data is determined to be low reliability data, the memory controller is configured to store the received data at a second number of locations in the memory device, wherein the first number of locations is greater than the second number of locations.

28. A method for storing data in a memory device, comprising:
receiving data for storing into the memory device;
determining a category of the received data from at least two different categories of data, wherein each category has a respective access method for storing data to the memory device; and
storing the data in the memory device according to the respective access method associated with the determined category.

29. The method of claim 28, wherein the at least two categories of data comprise high reliability data and low reliability data.

30. The method of claim 29, wherein if the category of the received data is determined to be high reliability data, the access method comprises storing the received data at a first clock frequency, and if the category of the received data is determined to be low reliability data, the access method comprises storing the received data at a second clock frequency, wherein the first clock frequency is lower than the second clock frequency.

31. The method of claim 29, wherein if the category of the received data is determined to be high reliability data, the access method storing the received data with a first number of error correction bits, and if the category of the received data is determined to be low reliability data, the access method comprises storing the received data with a second number of error correction bits, wherein the first number of error correction bits is greater than the second number of error correction bits.

32. The method of claim 29, wherein if the category of the received data is determined to be high reliability data, the access method comprises storing the received data at a first number of locations in the memory device, and if the category of the received data is determined to be low reliability data, the access method comprises storing the received data at a second number of locations in the memory device, wherein the first number of locations is greater than the second number of locations.
